(19) United States
(12) Patent Application Publication
(10) Pub. No.: US 2024/0222989 A1
(43) Pub. Date: Jul. 4, 2024

(54) CHARGING CONTROL DEVICE AND CHARGING CONTROL METHOD

(71) Applicant: DENSO TEN Limited, Kobe-shi (JP)

(72) Inventor: Masatoshi HAGIWARA, Kobe (JP)

(73) Assignee: DENSO TEN Limited, Kobe-shi (JP)

(21) Appl. No.: 18/603,504

(22) Filed: Mar. 13, 2024

Related U.S. Application Data
(63) Continuation of application No. PCT/JP2021/048710, filed on Dec. 27, 2021.

(51) Int. Cl. H02J 7/00; B60L 53/60

(52) U.S. Cl. CPC H02J 7/0048; H02J 7/0071; B60L 53/60

(57) ABSTRACT

A charging control device including a controller that controls charging a battery that is mounted on a vehicle using an external power, wherein the controller is able to set a first charging mode in which charging is completed when a state of charge becomes a first target of charge close to full charging, and further is able to set a second charging mode in which charging is completed when a state of charge becomes a second target state of charge that is lower than the first target state of charge, and the controller is configured to: in a case of the first charging mode, control a timing when charging is completed based on a traveling due time, and in a case of the second charging mode, execute control such that the timing when charging is completed before the timing when charging is completed in the first charging mode.

### CROSS-REFERENCE TO RELATED APPLICATION

This application is a continuation of International Application No. PCT/JP2021/048710, filed on Dec. 27, 2021, the entire contents of which are incorporated herein by reference.

### FIELD

The embodiment discussed herein is directed to a charging control device and a charging control method.

### BACKGROUND

There have been charging control devices that control charging a secondary battery, such as a lithium battery. For the charging control devices, there is a technique of delaying a start of charging starts such that a state close to the full charge does not continue for a long time in terms of avoiding deterioration of the secondary battery (refer to, for example, Japanese Laid-open Patent Publication No. 2021-078303).

With the conventional technique, because the time when charging ends delays by the delay of the start of charging, the situation where charging does not complete until the next traveling is assumed.

### SUMMARY

A charging control device including a controller that controls charging a battery that is mounted on a vehicle using an external power, wherein
the controller is able to set a first charging mode in which charging is completed when a state of charge becomes a first target of charge close to full charging, and further is able to set a second charging mode in which charging is completed when a state of charge becomes a second target state of charge that is lower than the first target state of charge, and
the controller is configured to:
   in a case of the first charging mode, control a timing when charging is completed based on a traveling due time, and
   in a case of the second charging mode, execute control such that the timing when charging is completed before the timing when charging is completed in the first charging mode.

### BRIEF DESCRIPTION OF DRAWINGS

FIG. 1 is a diagram illustrating an example in which a charging control device is mounted;

FIG. 2 is a diagram illustrating an overview of a charging control method;

FIG. 3 is a block diagram of the charging control device;

FIG. 4 is a diagram illustrating a relationship between the environmental temperature and the wait time;

FIG. 5 is a diagram illustrating an example of a notification screen; and

FIG. 6 is a flowchart illustrating a procedure of a process that is executed by the charging control device.

### DESCRIPTION OF EMBODIMENTS

An embodiment of a charging control device and a charging control method that are disclosed herein will be described in detail below with reference to the accompanying drawings. Note that the embodiment described below does not limit the disclosure.

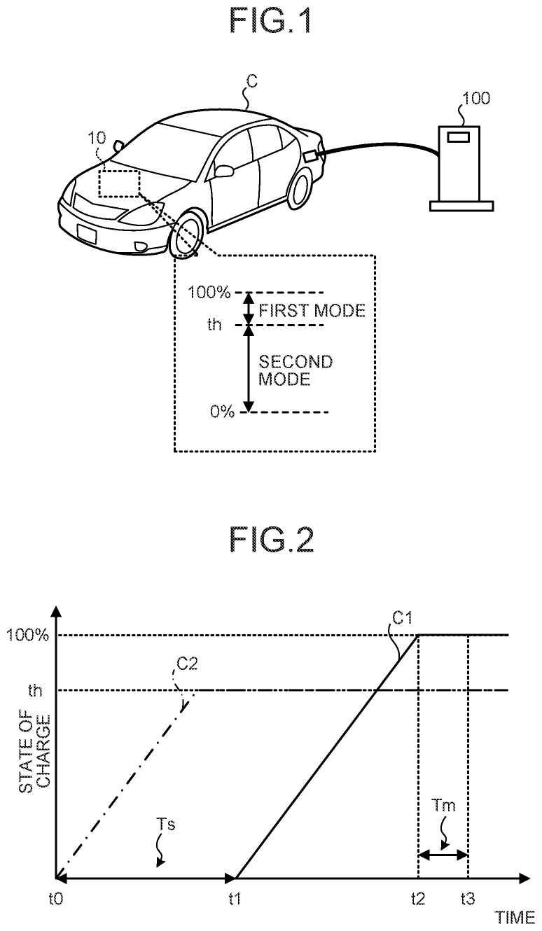

First of all, using FIG. 1 and FIG. 2, the overview of the charging control device and the charging control method according to the embodiment will be described. FIG. 1 is a diagram illustrating an example in which the charging control device is mounted. FIG. 2 is a diagram illustrating an overview of the charging control method.

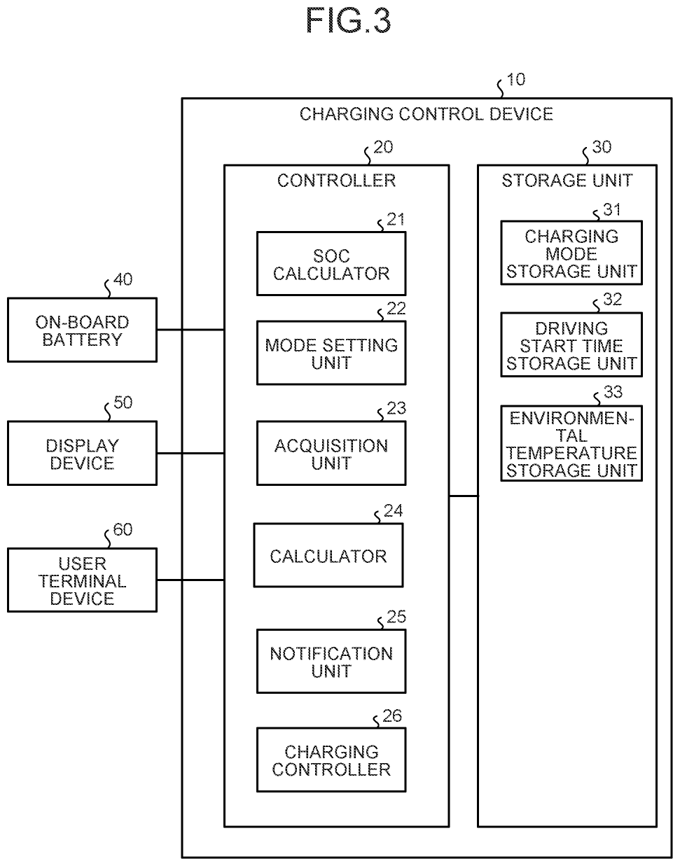

As illustrated in FIG. 1, a charging control device 10 according to the embodiment is mounted on a vehicle C. The vehicle C has an on-board battery 40 (refer to FIG. 3) that is a secondary battery, such as a lithium battery, and the charging control device 10 controls charging the on-board battery 40 using an external power 100. The example in FIG. 1 presents the case where the external power 100 is a contact charging device that supplies power via a cable; however, the external power 100 may be a non-contact charging device.

It is possible to inhibit deterioration of the secondary battery, for example, a lithium ion battery, in general by using the battery at a state of charge between 30 and 80%. In other words, for example, when the state of charge of the secondary battery after being charged exceeds 80%, while the distance that the vehicle C is able to travel increases, it is a cause of deterioration of the secondary battery.

For this reason, the charging control device 10 according to the embodiment sets, as a mode of charging the on-board battery 40, a first mode in which a state of charge exceeding a recommended charging threshold th for the on-board battery 40 is a target state of charge and a second mode in which a state of charge lower than the recommended charging threshold th is a target state of charge.

For example, the recommended charging threshold th is a threshold for the state of charge that is recommended in terms of deterioration of the secondary battery and is, for example, a state of charge of 80%. The first mode is a full-charge mode aimed at fully charging the on-board battery 40 and the second mode is a deterioration-inhibiting mode aimed at inhibiting deterioration of the on-board battery 40.

In other words, in the first mode, the charge tends not to be run out and, in the second mode, it is possible to inhibit the on-board battery 40 from deteriorating. In the embodiment, the case where the target state of charge exceeds the recommended charging threshold th is defined as the first mode and the case where the target state of charge is at or under the recommended charging threshold th is defined as the second mode.

As for each charging mode, a mode in which a state of charge close to the full charge is the target state of charge may be the first mode and a mode in which a state of charge lower than that in the first mode is the target state of charge may be the second charging mode and, alternatively, a mode in which a state of charge at which deterioration tends not to occur is the target state of charge may be the second charging mode and a mode in which a state of charge higher than that in the second charging mode is the target state of charge may be the first charging mode.

As described above, the longer the time during which the state of charge exceeds the recommended charging threshold th is, the more the on-board battery 40 tends to further deteriorate. For this reason, when the mode of charging the on-board battery 40 is the first mode, shortening the time during which the state of charge exceeds the recommended charging threshold th makes it possible to inhibit the on-board battery 40 from further deteriorating.

Thus, the charging control device 10 according to the embodiment sets a time during which the recommended threshold th is exceeded is set in accordance with the next driving start time in the first mode while performing instantaneous charging in the second mode.

Specifically, as illustrated in FIG. 2, in the first mode, after a state in which charging is possible is prepared, a wait time Ts is set in accordance with the driving start time. Note that, in FIG. 2, the vertical axis represents the state of charge and the horizontal axis represents the elapsed time.

Note that the state in which charging is possible is a state in which it is possible to start charging or a state in which a preparation for charging is done. In an example of the state in which charging is possible, in the case of wired charging, a charging plug that is provided on a cable of an external charger is being attached to a vehicle and, in the case of wireless charging, a vehicle is parked in align with a parking position in which a wireless charger is set (Condition A).

The state in which charging is possible may include at least any one of the case where the power SW of the vehicle is turned off (IG-OFF) and closing a door is detected and accordingly it is detected that a passenger gets out of the vehicle and the case where a start operation is performed in a way that the user operates a charging start switch, or the like (Condition B). For example, the state where charging is possible may be determined according to the condition A or according to a combination of the conditions A and B.

For example, according to FIG. 2, a time t0 is a time at which charging from the external power 100 to the on-board battery 40 is made possible and a time t3 is a driving start time. In this case, as for a state of charge C2 in the case where the charging mode is the second mode, charging is started from a time t0 and charging completes at the recommended charging threshold th.

On the other hand, as for a state of charge C1 in the case where the charging mode is the first mode, a wait time Ts is set such that charging completes at a time t2 obtained by subtracting a margin Tm from the time t3 that is the driving start time (the time at which driving is expected or predicted to start). Note that the margin Tm corresponds to an example of a first time. In other words, in the example illustrated in FIG. 2, charging from the external power 100 to the on-board battery 40 is not performed during the period from the time to until a time t1 and charging starts at the time t1.

Thereafter, the state of charge C1 in the case of the first mode increases from the time t1 gradually and reaches 100% at the time t2. In other words, in this case, it is possible to shorten the time during which the state of charge exceeds the recommended threshold th by the wait time Ts that is set and thus it is possible to inhibit deterioration of the on-board battery 40.

As described above, while the charging control device 10 according to the embodiment waits the wait time Ts and then starts charging after the wait time Ts elapses in the first mode, the charging control device 10 instantaneously starts charging in the second mode.

Thus, according to the charging control device 10 according to the embodiment, it is possible to avoid the situation in which charging does not complete until the next traveling while inhibiting deterioration of the secondary battery. In the second mode, charging can be kept completed at the target state of charge at timing earlier than in the first mode and therefore, even when the user hastily tries to use the vehicle earlier than the due time at which driving is expected to start, it can be dealt with.

Using FIG. 3, an example of the configuration of the charging control device 10 according to the embodiment will be described. FIG. 3 is a block diagram of the charging control device 10. FIG. 3 illustrates the on-board battery 40, a display device 50, and a user terminal device 60 together.

The on-board battery 40 is, for example, a lithium-ion secondary battery and supplies power to a motor and various types of accessories (loads) that are not illustrated in the drawings. The on-board battery 40 is charged by the external power 100 and a regenerative electric power that is generated when the vehicle C decelerates.

The display device 50 is, for example, a display device that is set in a dashboard of the vehicle C, or the like. The display device 50, for example, consists of a touch panel display and includes an operation unit. The display device 50 may have a function of a navigation apparatus.

The user terminal device 60, for example, is a smartphone or a table terminal device of the user. For example, the user terminal device 60 makes a communication connection with the charging control device 10 by wired or wireless communication. Note that the user terminal device 60 may make a communication connection with the charging control device 10 via the display device 50.

As illustrated in FIG. 3, the charging control device 10 includes a controller 20 and a storage unit 30. The storage unit 30 is realized using a semiconductor memory device, such as a random access memory (RAM) or a flash memory, and, in the example in FIG. 3, includes a charging mode storage unit 31, a driving start time storage unit 32, and an environmental temperature storage unit 33.

The charging mode storage unit 31 is a storage unit that stores a charging mode that is set currently. The driving start time storage unit 32 is a storage unit that stores a driving start time. The charging control device 10 may set a time that is input by the user when preparing for charging as the driving start time, may specify the next driving start time based on schedule information that is input by the user to the display device 50 or schedule information that is input to the user terminal device 60, or may estimate the next driving start time from the tendency of driving starting times in the past.

The environmental temperature storage unit 33 stores environmental temperatures until the next traveling due time at a parking spot. For example, the environmental temperature storage unit 33 stores information on temperatures until the next traveling due time at the charging spot of the vehicle C as environmental temperatures. For example, the charging control device 10 requests the user terminal device 60 to acquire an environmental temperature and the user terminal device 60 stores an environmental temperature that is acquired via the Internet in the environmental temperature storage unit 33.

The controller 20 is a controller and, for example, is realized in a way that various types of programs not illustrated in the drawings and stored in the storage unit 30 are executed by a central processing unit (CPU), a micro processing unit (MPU), or the like, using a RAM as a work area. The controller 20 can be realized using an integrated circuit, such as an application specific integrated circuit (ASIC) or a field programmable gate array (FPGA).

As illustrated in FIG. 3, the controller 20 includes a state of charge (SOC) calculator 21, a mode setting unit 22, an acquisition unit 23, a calculator 24, a notification unit 25, and a charging controller 26.

The SOC calculator 21 calculates a state of charge (SOC) of the on-board battery 40. The SOC calculator 21, for example, calculates a state of charge using a given method, such as a current addition, an open circuit voltage (OCV) estimation, or extended Kalman filtering.

The mode setting unit 22 sets a charging mode of the on-board battery 40 according to an operation of the user. For example, the mode setting unit 22 sets a mode of charging the on-board battery 40 according to operation information that is input from the display device 50 or operation information that is input from the user terminal device 60. The mode setting unit 22 writes in the charging mode storage unit 31 every time the mode setting unit 22 sets a charging mode.

The acquisition unit 23 acquires information on the driving start time and information on environmental temperatures. For example, when the charging mode is a first mode, the acquisition unit 23 causes the display device 50 or the user terminal device 60 to display an input screen for inputting the next driving start time at timing of IG-OFF.

By acquiring input information to the input screen to the input screen from the display device 50 or the user terminal device 60, the acquisition unit 23 acquires the information on the next driving start time and writes the information in the driving start time storage unit 32.

When the charging mode is the first mode, the acquisition unit 23 requests the display device 50 or the user terminal device 60 to acquire an environmental temperature and acquires an environmental temperature that is acquired by the display device 50 or the user terminal device 60 via the Internet. For example, in this case, the acquisition unit 23 acquires prediction information on a temperature at the next driving start time in the current position of the vehicle C.

The calculator 24 calculates charging start timing in the first mode. For example, the calculator 24 calculates charging start timing such that timing obtained by subtracting a margin Tm (refer to FIG. 2) from the next driving start time is charging completion timing.

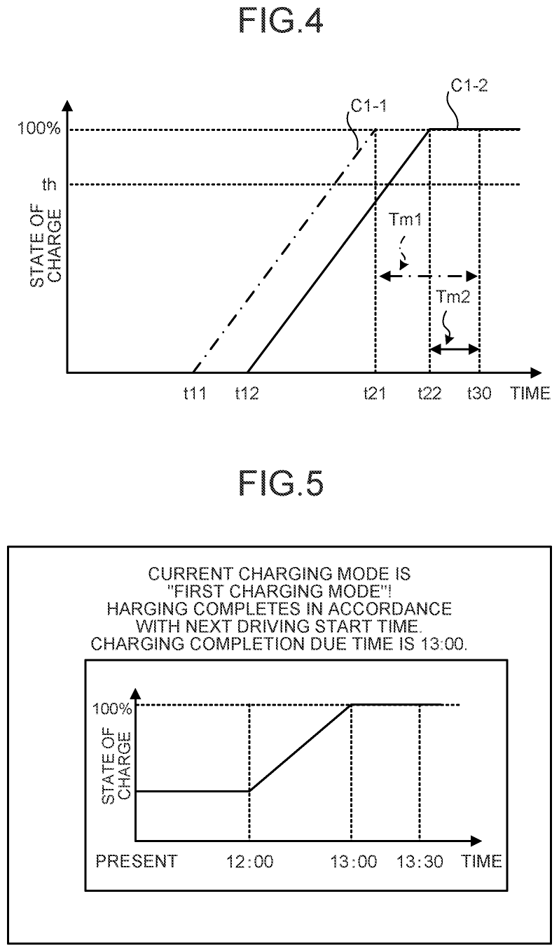

The calculator 24 may adjust the margin Tm based on the environmental temperature and then calculate charging start timing. FIG. 4 is a diagram illustrating a relationship between the environmental temperature and the margin. FIG. 4 presents the state of charge on the vertical axis and the time on the horizontal axis.

Deterioration of the on-board battery 40 depends on the environmental temperature in addition to the state of charge. More specifically, the higher the environmental temperature of the environment is, the more the on-board battery 40 tends to deteriorate. For this reason, when the state of charge of the on-board battery 40 is exceeding the recommended charging threshold th and the environmental temperature is high, deterioration of the on-board battery 40 is promoted.

For this reason, for example, when the environmental temperature is high, the calculator 24 sets the margin TM shorter and calculates charging start timing. The example illustrated in FIG. 4 represents the case where the environmental temperature is high as a state of charge C1-2 using a state of charge C1-1 for which the environmental temperature is not taken into consideration as a reference.

In other words, while a margin Tm1 for the state of charge C1-1 is “t30-t21”, a margin Tm2 for the state of charge C1-2 is “t30-t22”, and the margin Tm2 is shorter than the margin Tm1 by “t-22-t21” substantially. Accordingly, the charging start timing at the time t11 is calculated as a time t12.

As described above, taking the environmental temperature into consideration makes it possible to further inhibit the on-board battery 40 from deteriorating. Note that, for example, as for the relationship between the margin Tm and the environmental temperature, an appropriate value may be determined in advance by simulation, or the like, and the calculator 24 may set a margin Tm using the value. In addition to setting based on the temperature, the calculator 24 may estimate whether the temperature tends to increase based on the time of day (morning, afternoon, evening, or the like) of the driving start time and seasonal information based on the date and sets the margin Tm.

Back to description in FIG. 3, the notification unit 25 will be described. The notification unit 25 makes a notification of information on the current charging mode at the timing of IG-OFF. For example, the notification unit 25 notifies the user of the information on the current charging mode by displaying the current charging mode on the display device 50 or the user terminal device 60.

Accordingly, after referring to the current charging mode, the user is able to change the charging mode in accordance with the schedule of the user after charging completes and therefore it is possible to appropriately support the user in setting a charging mode.

When the charging mode is the first mode, the notification unit 25 may notify the user of information on the wait time Ts or notify the user that charging is not started instantly in the first mode at timing when charging is made possible, such as timing when the charging plug of the external power 100 is connected to the on-board battery 40 (timing when charging is started in the case where the second mode is set).

As described above, when the charging mode is the first mode, charging is started after the wait time Ts (refer to FIG. 2). For this reason, for example, when the user forgets to change the driving start time, there is a possibility that charging does not complete until the original driving start time and the state of charge is insufficient.

On the other hand, for example, the notification unit 25 notifies the user that charging is to be performed after the wait time Ts and thus is able to provide an opportunity of reconsidering to change the driving start time to the user, thereby making it possible to avoid a charge shortage because of lack of setting a driving start time. By making a notification as described above makes it possible to, in the case where the first mode is set, prevent the user from having a feeling of strangeness (wonder if a failure occurs) because charging is not started instantaneously.

For example, the notification unit 25 may make a notification of a charging schedule including the charging start timing in addition to the current charging mode. FIG. 5 is a diagram illustrating an example of the notification screen.

For example, the notification unit 25 may make a notification of a notification screen at the timing of IG-OFF, the timing when the external power 100 is connected to the on-board battery 40, or the like. In the example in FIG. 5, on the notification screen, the charging schedule presenting the charging start timing and the charging completion timing is displayed in a graph in addition to information on the current charging mode.

The example illustrated in FIG. 5 presents that the next driving start time is 13:30, the charging start timing is 12:00, and the charging completion timing is 13:00. For example, making a notification of such a notification screen enables the user to easily know the charging schedule and review the charging schedule easily.

The charging schedule in the case where the charging mode is the first mode is exemplified herein; however, needless to say, a notification of a charging schedule in the case where the charging mode is the second mode may be made.

Back to description of FIG. 3, the charging controller 26 will be described. The charging controller 26 controls charging the on-board battery 40 with the external power 100 (refer to FIG. 1). For example, the charging controller 26 starts charging at charging start timing corresponding to the current charging mode and completes charging when the set target state of charge is reached.

Specifically, when the charging mode is the first mode, the charging controller 26 waits until the charging start timing that is calculated by the calculator 24 and starts charging. When the charging mode is the second mode, the charging controller 26 starts charging at the stage where the charging plug of the external power 100 is connected to the on-board battery 40.

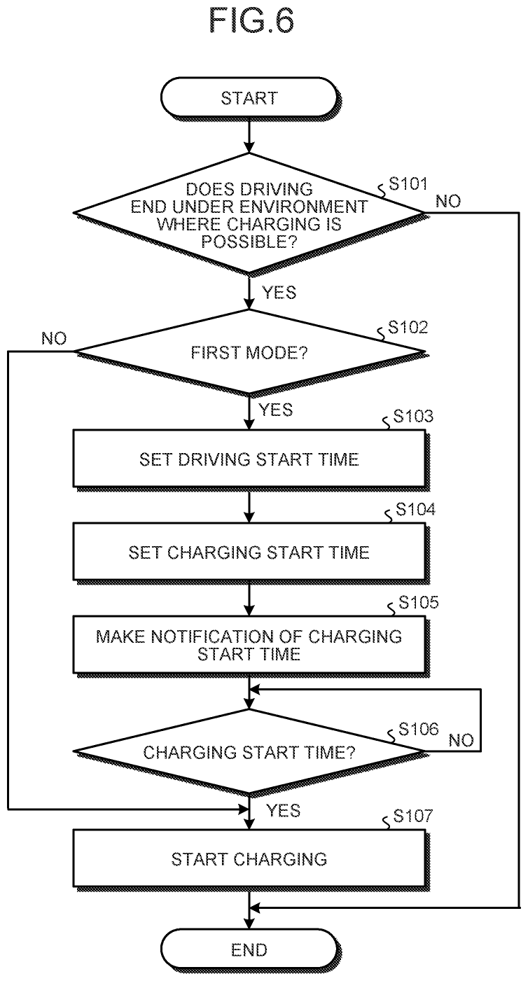

Using FIG. 6, a process procedure that the charging control device 10 according to the embodiment executes will be described. FIG. 6 is a flowchart illustrating the process procedure that the charging control device 10 executes.

As illustrated in FIG. 6, first of all, the charging control device 10 determines whether driving ends under an environment where it is possible to charge the vehicle C (step S101). When it is determined that driving ends under the environment where charging is possible (YES at step S101), the charging control device 10 goes to the process at step S102 and, when it is determined that driving does not end under the environment where charging is possible (NO at step S101), the charging control device 10 ends the process.

The charging control device 10 then determines whether the current charging mode is the first mode (step S102) and, when the charging mode is the first mode (YES at step S102), for example, sets a driving start time according to an operation of the user, or the like (step S103).

Subsequently, the charging control device 10 sets a charging start time based on the driving start time (step S104) and notifies the user of the charging start time that is set (step S105). Thereafter, the charging control device 10 determines whether the charging start time comes (step S106).

When it is determined that the charging start time comes (YES at step S106), the charging control device 10 starts charging (step S107) and ends the process. When it is determined that the charging start time does not come (NO at step S106), the charging control device 10 continues the process at step S106.

When it is determined in determination at step S102 that the charging mode is the second mode (NO at step S102), the charging control device 10 moves to the process at step S107.

As described above, the charging control device 10 according to the embodiment is a charging control device including the controller 20 that controls charging the battery that is mounted on the vehicle using the external power 100 and the controller 20 is able to set, as a mode of charging the on-board battery 40 (an example of a battery), a charging mode from the first mode in which the first state of charge that is a state of charge close to the full charge is the target state of charge and the second mode in which the second state of charge lower than the first state of charge is the target state of charge, when the charging mode is the first mode, the controller 20 controls charging such that charging completes at the charging completion timing based on the next traveling due time and, when the charging mode is the second mode, the controller 20 controls charging such that charging completes at timing earlier than the charging completion timing of the first mode.

Thus, according to the charging control device 10 according to the embodiment, it is possible to avoid the situation where charging does not complete until the next traveling while inhibiting deterioration of the secondary battery.

As described above, the charging control device 10 according to the embodiment is a charging control device including the controller 20 that controls charging the battery that is mounted on the vehicle using the external power 100 and the controller 20 is able to set, as a mode of charging the on-board battery 40 (an example of a battery), a charging mode from the first mode in which the first state of charge that is a state of charge close to the full charge is the target state of charge and the second mode in which the second state of charge lower than the first state of charge is the target state of charge, when the charging mode is the first mode, the controller 20 starts charging at timing based on the next traveling due time and, when the charging mode is the second mode, the controller 20 starts charging at timing when preparation for starting charging is done.

Thus, according to the charging control device 10 according to the embodiment, it is possible to avoid the situation where charging does not complete until the next traveling while inhibiting deterioration of the secondary battery.

As for the above-described embodiment, the case where the instantaneous charging is performed in the second mode has been described; however, charging is not limited to this. In other words, charging may be performed after the wait time Ts as appropriate also in the second mode. For example, the wait time Ts may be set such that charging is performed in a time of day during which the electric rate is low. In other words, charging need not necessarily start instantaneously in the second mode, there is no problem even if charging is performed after a while after the state where charging is made possible, and charging only need start at timing sufficiently earlier than the charging start timing in the first mode. Also in the second mode, when starting charging is delayed, making a notification as in the case of the first mode is particularly effective.

As for setting charging start timing and setting charging end timing, because it is possible to calculate one of the sets of timing by adding or subtracting a time necessary for charging to or from the other set of timing, one of the sets of timing may be referred to as the other set of timing as the timing described in the description.

As for the above-described embodiment, the case where charging the on-board battery 40 is controlled has been described; however, the battery is not limited to this. In other words, it is possible to replace the on-board battery 40 with various secondary batteries. In other words, the disclosure may be applied to control on a secondary battery of a personal computer, a smartphone, or the like.

According to the disclosure, it is possible to avoid the situation where charging does not complete until the next traveling while inhibiting deterioration of a secondary battery.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A charging control device comprising a controller that controls charging a battery that is mounted on a vehicle using an external power, wherein
the controller is able to set a first charging mode in which charging is completed when a state of charge becomes a first target of charge close to full charging, and further is able to set a second charging mode in which charging is completed when a state of charge becomes a second target state of charge that is lower than the first target state of charge, and
the controller is configured to:
in a case of the first charging mode, control a timing when charging is completed based on a traveling due time, and
in a case of the second charging mode, execute control such that the timing when charging is completed before the timing when charging is completed in the first charging mode.

2. The charging control device according to claim 1, wherein
the controller is further configured to:
in a case of the first charging mode, execute control such that charging is completed at a timing that is earlier than the traveling due time by a first time.

3. The charging control device according to claim 2, wherein
the controller is further configured to:
adjust the first time based on an environmental temperature at the traveling due time.

4. The charging control device according to claim 1, wherein
the controller is further configured to:
in a case of the first charging mode, delay a charging start time until a timing at which charging up to the first target state of charge at the traveling due time is possible.

5. The charging control device according to claim 4, wherein
the controller is further configured to:
notify a user of the charging start time.

6. The charging control device according to claim 1, wherein
the controller is further configured to:
in a case of the second charging mode, start charging in a case where a preparation for charging is completed.

7. The charging control device according to claim 1, wherein
the controller is further configured to:
in a case of the second charging mode and further where charging is not immediately started after completion of a preparation for charging, notify a user of a delay of start of charging.

8. A charging control method of a battery that is mounted on a vehicle by using an external power, the method being executed by a controller and comprising:
being able to set a first charging mode in which charging is completed when a state of charge becomes a first target of charge close to full charging, and further to set a second charging mode in which charging is completed when a state of charge becomes a second target state of charge that is lower than the first target state of charge;
in a case of the first charging mode, controlling a timing when charging is completed based on a traveling due time; and
in a case of the second charging mode, executing control such that the timing when charging is completed before the timing when charging is completed in the first charging mode.

9. A charging control device comprising a controller that controls charging a battery that is mounted on a vehicle using an external power, wherein
the controller is able to set a first charging mode in which charging is completed when a state of charge becomes a first target of charge close to full charging, and further is able to set a second charging mode in which charging is completed when a state of charge becomes a second target state of charge that is lower than the first target state of charge, and
the controller is configured to:
in a case of the first charging mode, control a timing of start of charging based on a traveling due time; and
in a case of the second charging mode, start charging when a preparation for charging is completed.
